(19) United States
(12) Patent Application Publication
(10) Pub. No.: US 2009/0080651 A1
(43) Pub. Date: Mar. 26, 2009

(54) SEMICONDUCTOR WITH HARDWARE LOCKED INTELLECTUAL PROPERTY AND RELATED METHODS

(75) Inventors: Soumya BANERJEE, San Jose, CA (US); Paritosh KULKARNI, San Jose, CA (US)

Correspondence Address: MIPS c/o COOLEY GODWARD KRONISH LLP, 777 6TH STREET NW SUITE 1100, ATTN: PATENT GROUP / WSG-PA, WASHINGTON, DC, 20001, US

(73) Assignee: MIPS TECHNOLOGIES, INC., Mountain View, CA (US)

(21) Appl. No.: 11/862,154

(22) Filed: Sep. 26, 2007

(51) Int. Cl. G06F 12/14; H04L 9/00

(52) U.S. Cl. 380/46; 713/194

(57) ABSTRACT

A computer readable medium includes executable instructions to describe an intellectual property core with a key check mechanism configured to compare an external key with an internal key in response to a specified event. A pending instruction is executed in response to a match between the external key and the internal key. An unexpected act is performed in response to a mismatch between the external key and the internal key.

### BRIEF DESCRIPTION OF THE INVENTION

This invention relates generally to the protection of intellectual property assets. More particularly, this invention relates to the specification and formation of a semiconductor with hardware locked intellectual property.

### BACKGROUND OF THE INVENTION

Various entities, such as MIPS Technologies, Inc., of Mountain View, Calif. provide solutions to facilitate the design of physical products, such as semiconductors. These solutions, often embodied as computer executable software, are commonly referred to as intellectual property (IP). There are many legitimate transactions that facilitate the rightful use of IP. However, the nature of many forms of IP, for example IP manifested in computer executable software, may result in unlicensed entities utilizing the IP, for example by unauthorized copying of the computer executable software.

Therefore, it would be desirable to provide a mechanism to distribute IP to rightful users while thwarting attempts of unauthorized users from exploiting the IP rights of others.

### SUMMARY OF THE INVENTION

The invention includes a semiconductor with an intellectual property core with a key check mechanism configured to compare an external key with an internal key in response to a specified event. A pending instruction is executed in response to a match between the external key and the internal key. An unexpected act is performed in response to a mismatch between the external key and the internal key.

The invention also includes a system on a chip with a set of proprietary intellectual property blocks and a key source block. An intellectual property core with a key check mechanism is configured to compare an external key from the key source block with an internal key in response to a specified event. A pending instruction is executed in response to a match between the external key and the internal key. An unexpected act is performed in response to a mismatch between the external key and the internal key.

The invention also includes a computer readable medium with executable instructions to describe an intellectual property core with a key check mechanism configured to compare an external key with an internal key in response to a specified event. A pending instruction is executed in response to a match between the external key and the internal key. An unexpected act is performed in response to a mismatch between the external key and the internal key.

The invention also includes a computer readable medium with executable instructions to describe a set of proprietary intellectual property blocks and a key source block. An intellectual property core with a key check mechanism is configured to compare an external key from the key source block with an internal key in response to a specified event. A pending instruction is executed in response to a match between the external key and the internal key. An unexpected act is performed in response to a mismatch between the external key and the internal key.

The invention also includes a method of producing a system on a chip by delivering an intellectual property core with a key check mechanism. The intellectual property core is combined with a key source block and a set of proprietary intellectual property blocks.

### BRIEF DESCRIPTION OF THE FIGURES

The invention is more fully appreciated in connection with the following detailed description taken in conjunction with the accompanying drawings, in which:

FIG. 1 illustrates a computer configured in accordance with an embodiment of the invention.

FIG. 2 illustrates processing operations associated with an embodiment of the invention.

FIG. 3 illustrates a system-on-a-chip (SOC) configured in accordance with an embodiment of the invention.

FIG. 4 illustrates a hardware lock mechanism configured in accordance with an embodiment of the invention.

FIG. 5 illustrates key match processing associated with an embodiment of the invention.

FIG. 6 illustrates static key comparison performed in accordance with an embodiment of the invention.

FIG. 7 illustrates dynamic key comparison performed in accordance with an embodiment of the invention.

Like reference numerals refer to corresponding parts throughout the several views of the drawings.

### DETAILED DESCRIPTION OF THE INVENTION

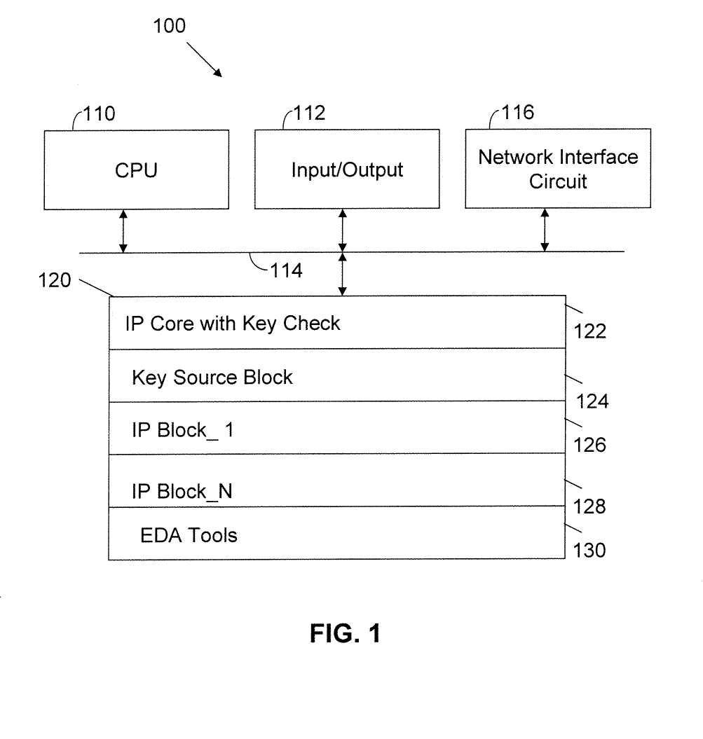

FIG. 1 illustrates a computer 100 configured in accordance with an embodiment of the invention. The computer 100 includes standard components, such as a central processing unit (CPU) 110 connected to a set of input/output devices 112 via a bus 114. The input/output devices 112 may include a keyboard, mouse, display, printer, and the like. A network interface circuit 116 may also be connected to the bus 114 to facilitate communication with a network (not shown). Thus, the invention may be operated in a networked environment.

A memory 120 is also connected to the bus 114. The memory 120 stores data and executable instructions to implement operations associated with embodiments of the invention. The memory 120 stores an IP core with a key check. The IP core with a key check 120 includes executable instructions to specify a semiconductor core that relies upon a key check mechanism to thwart unauthorized use of the IP core. The semiconductor core may be a microprocessor core, a digital signal processor (DSP) core, and the like. Memory 120 also stores a key source block 124. The key source block 124 includes executable instructions to specify a semiconductor key source that is supplied to the IP core with key check 122. Typically, the key source block is only supplied to a trusted partner, such as a design service firm or semiconductor fabricator. As discussed below, the IP core with key check 122 is only operative with the key source block 124. Therefore, if the IP core with key check 122 is misappropriated, it will be inoperative in the absence of the key source block 124.

The memory 120 may also store a set of proprietary IP blocks, such as IP block_1 126 and IP block_N 128. As known in the art, an IP core is typically combined with various proprietary IP blocks so that a customer can produce a system-on-a-chip (SOC) with a desired function. For example, MIPS 1Technologies, Inc., of Mountain View, Calif., provides microprocessor cores that may be combined with proprietary IP blocks to form SOCs used in cable modems, DVD recorders, digital cameras, printers and copiers.

The memory 120 may also include a set of Electronic Design Automation (EDA) tools 130. These tools 130 may include a Register Transfer Level (RTL) synthesizer, a logic analyzer timing analyzer and place and route tools (i.e., silicon compilers). These tools are used to specify an SOC that incorporates the IP core with key check 122, the key source block 124, and the IP blocks 126 and 128.

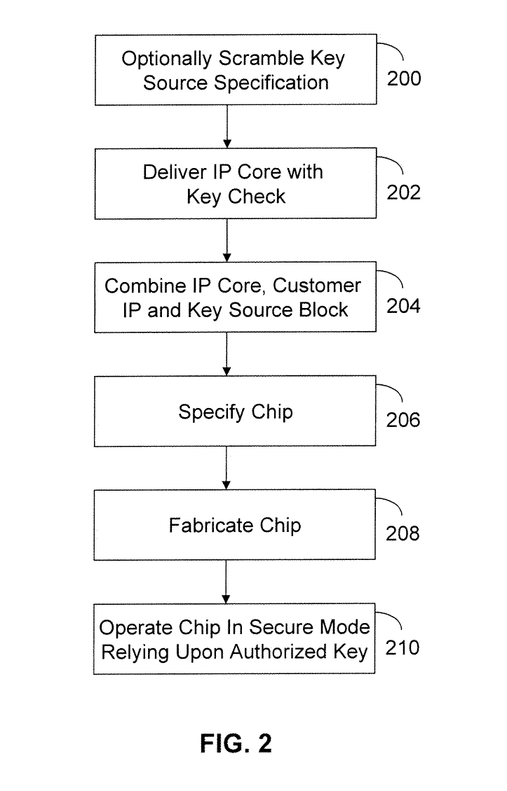

FIG. 2 illustrates processing operations associated with an embodiment of the invention. The first operation of FIG. 2 is to optionally scramble a key source specification 200. An embodiment of the invention includes the utilization of a random number generator to produce dynamic keys. The specification of this random number generator (e.g. in RTL) may be scrambled (e.g., logical component names may be changed to illogical names and the code may be distributed in non-intuitive ways across all of the RTL code). This makes it difficult for a pirate to replicate the function of the random number generator.

The next processing operation of FIG. 2 is to deliver an IP core with key check 202. Typically, the IP core with key check is delivered to a licensed user in a legitimate transaction between the vendor of the IP core and a customer that wants to combine the IP core with proprietary IP blocks.

The next processing operation of FIG. 2 is to combine the IP core with key source and customer IP 204. This operation entails standard processes to combine an IP core with proprietary IP blocks to form an SOC. This operation also involves supplying the key source block to a trusted partner that embeds the key source block in an SOC.

The next operation of FIG. 2 is to specify a chip, such as an SOC 206. The chip is specified in a conventional manner to allow it to be fabricated. The EDA tools 130 (e.g., an RTL synthesizer, a logic analyzer and a place and route tool) may be used to implement this operation. The chip or SOC is then fabricated 208. The resultant chip or SOC is then operated in a secure mode utilizing an authorized key 210.

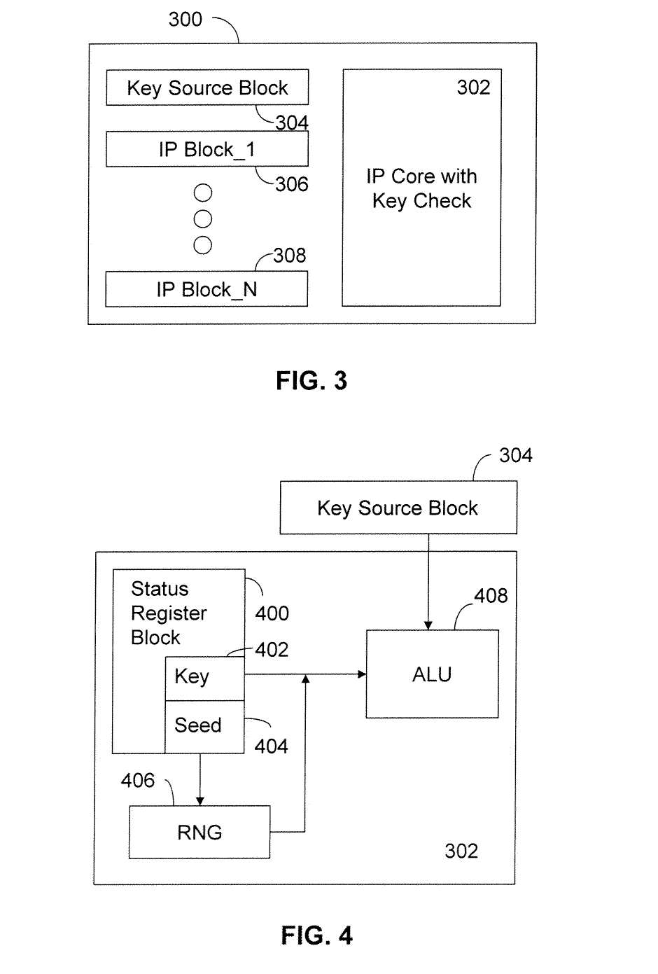

FIG. 3 illustrates an SOC 300 formed in accordance with an embodiment of the invention. The SOC 300 includes an IP core with key check 302. As indicated above, this module is supplied by a vendor to a licensed customer. The SOC 300 also includes a key source block 304. As previously stated, the key source block 304 is supplied by the vendor of the IP core 302 to a trusted partner. The trusted partner, not the licensee of the IP core 302, controls the specification of the key source block 304 in the SOC 300. In other words, this portion of a licensee's SOC is invisible to the licensee as it is controlled by the trusted partner. The SOC 300 also includes proprietary IP blocks 306-308 that are used, in combination with the IP core 302, to implement the function of the SOC 300.

FIG. 4 illustrates an embodiment of an IP core with key check 302. As shown in FIG. 4, the IP core 302 operates with the key source block 304. The key source block 304 may be implemented to specify a static value (i.e., a static key). The static value is supplied to the trusted partner who burns the value into the SOC 300. For example, the static value is stored in a Programmable Read Only Memory (PROM) formed on the SOC. In another embodiment, the key source block 304 is implemented with a seed and a random number generator. The seed is provided as input to the random number generator, which subsequently generates dynamic values (i.e., dynamic keys).

In one embodiment, the IP core 302 is configured to include a status register block 400 with storage for a key 402 and/or a seed 404. In one embodiment, the status register block 400 is software configurable to disable the key check mechanism.

In an embodiment utilizing a static value, a static key value 402 is supplied with the IP core 302. The static key value is periodically supplied to a comparison mechanism, such as an Arithmetic Logic Unit (ALU) 408. The ALU also receives a static value from the key source block 304. If the static key from the status register block 400 matches the static key received from the key source block 304 the next pending instruction is processed. If the comparison does not result in a match, then an unexpected action is taken. The unexpected action disrupts the proper operation of the IP core 302 and/or the SOC 300. In an embodiment utilizing a dynamic value, a seed 404 is supplied to a random number generator 406, which periodically supplies dynamic key values to the ALU 408. The key source block 304 includes an identical seed value and random number generator and therefore generates the same sequence of dynamic key values to the ALU 408.

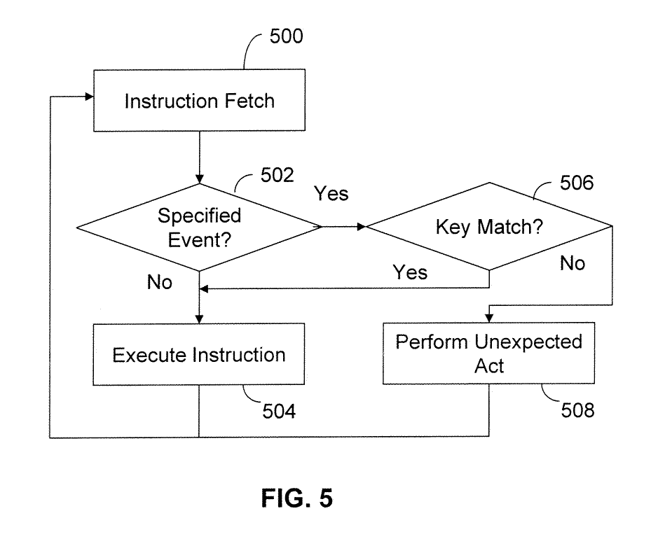

The foregoing operations are more fully appreciated with reference to FIG. 5. FIG. 5 illustrates key processing operations associated with an embodiment of the invention. In particular, FIG. 5 illustrates processing operations performed by an IP core with key check associated with an embodiment of the invention. The IP core 302 fetches an instruction 500. If the instruction is not associated with a specified event (502—NO), then the instruction is executed 504. The next instruction is then fetched 500. The specified event may occur after a predetermined number of intellectual property core cycles. For example, a comparison operation may be invoked after every 1 billion IP core cycles. Alternately, the specified event may occur after a predetermined number of instances of a specified instruction (e.g., after every 1 millionth branch instruction).

If a specified event has occurred (502—YES), then a key match operation is performed 506. If the match is successful (506—YES), then the next instruction is executed 504 and another instruction is fetched 500. If the key match is not successful (506—NO), then an unexpected act is performed 508. The unexpected act is selected to disrupt the proper operation of the IP core 302 and/or the SOC 300. Any number of unexpected acts may be utilized in accordance with the invention. By way of example, not limitation, the following unexpected acts may be taken: perform an incorrect branch, jump to a reset address, invoke a machine check exception, invoke a constant value, invoke a random value, skip an instruction, etc. The unexpected act results in incorrect operation of the IP core 302 and/or the SOC 300. Thus, an entity that has inappropriately pirated the IP core 302 cannot construct a useful SOC. Maintaining a low periodicity for key match comparisons makes it difficult for an unscrupulous entity to debug the problem, while having no meaningful performance impact on licensed users.

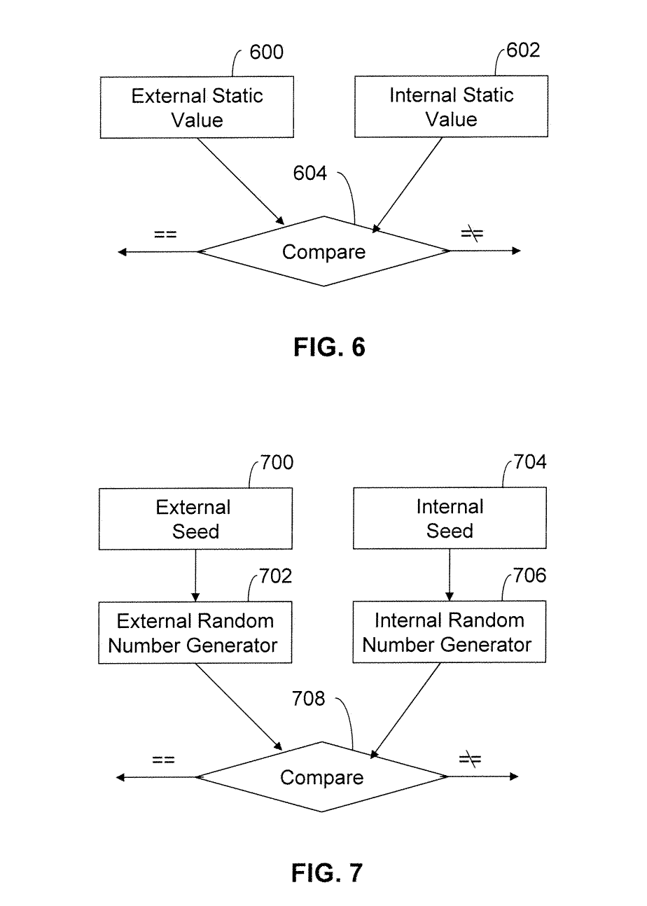

The key match comparison operation is more fully appreciated with reference to FIG. 6. FIG. 6 discloses a comparison between an external static value (e.g.., from the key source block 304) 600 and an internal static value (e.g., from the status register block 400) 602. If the comparison at block 604 is successful, the next instruction is executed; otherwise, an unexpected act is performed.

FIG. 7 illustrates the comparison of dynamic values. An external seed 700 is supplied to an external random number generator 702. This operation is performed by the key source block 304. An internal seed 704 is supplied to an internal number generator 706. This operation is performed by the random number generator 406 receiving a seed 404 from the status register block 400. If the comparison at block 708 is successful, the next instruction is executed; otherwise, an unexpected act is performed.

In sum, the invention provides a technique to protect IP assets. The technique thwarts unauthorized users of IP by making their chips faulty. The cost of securing authorized rights is lower than the cost of circumventing valid IP rights. Thus, the invention allows IP vendors to distribute their technology more widely without fear of misappropriation.

While various embodiments of the invention have been described above, it should be understood that they have been presented by way of example, and not limitation. It will be apparent to persons skilled in the relevant computer arts that various changes in form and detail can be made therein without departing from the scope of the invention. For example, in addition to using hardware (e.g., within or coupled to a Central Processing Unit (“CPU”), microprocessor, microcontroller, digital signal processor, processor core, System on chip (“SOC”), or any other device), implementations may also be embodied in software (e.g., computer readable code, program code, and/or instructions disposed in any form, such as source, object or machine language) disposed, for example, in a computer usable (e.g., readable) medium configured to store the software. Such software can enable, for example, the function, fabrication, modeling, simulation, description and/or testing of the apparatus and methods described herein. For example, this can be accomplished through the use of general programming languages (e.g., C, C++), hardware description languages (HDL) including Verilog HDL, VHDL, and so on, or other available programs. Such software can be disposed in any known computer usable medium such as semiconductor, magnetic disk, or optical disc (e.g., CD-ROM, DVD-ROM, etc.). The software can also be disposed as a computer data signal embodied in a computer usable (e.g., readable) transmission medium (e.g., carrier wave or any other medium including digital, optical, or analog-based medium). Embodiments of the present invention may include methods of providing the apparatus described herein by providing software describing the apparatus and subsequently transmitting the software as a computer data signal over a communication network including the Internet and intranets.

It is understood that the apparatus and method described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present invention should not be limited by any of the above-described exemplary embodiments, but should be defined only in accordance with the following claims and their equivalents.

1. A semiconductor, comprising:
an intellectual property core with a key check mechanism configured to:
compare an external key with an internal key in response to a specified event,
execute a pending instruction in response to a match between the external key and the internal key, and
perform an unexpected act in response to a mismatch between the external key and the internal key.

2. The semiconductor of claim 1 wherein the specified event occurs after a predetermined number of intellectual property core cycles.

3. The semiconductor of claim 1 wherein the specified event occurs after a predetermined number of instances of a specified instruction.

4. The semiconductor of claim 1 wherein the unexpected act is selected from an incorrect branch, a jump to a reset address, the invocation of a machine check exception, an invoked constant value, an invoked random value, and a skipped instruction.

5. A system on a chip, comprising:
a plurality of proprietary intellectual property blocks;
a key source block; and
an intellectual property core with a key check mechanism configured to:
compare an external key from the key source block with an internal key in response to a specified event,
execute a pending instruction in response to a match between the external key and the internal key, and
perform an unexpected act in response to a mismatch between the external key and the internal key.

6. The system of claim 5 wherein the key source block stores a static key value.

7. The system of claim 6 wherein the intellectual property core includes a status register block that stores a static key value.

8. The system of claim 5 wherein the key source block produces a first key from an external random number generator responsive to a specified seed.

9. The system of claim 8 wherein the intellectual property core produces a second key from an internal random number generator responsive to the specified seed.

10. The system of claim 9 wherein the specified seed is stored in a status register block of the intellectual property core.

11. A computer readable medium, comprising executable instructions to describe:
an intellectual property core with a key check mechanism configured to:
compare an external key with an internal key in response to a specified event,
execute a pending instruction in response to a match between the external key and the internal key, and
perform an unexpected act in response to a mismatch between the external key and the internal key.

12. The computer readable medium of claim 11, wherein the executable instructions dictate that the specified event occurs after a predetermined number of intellectual property core cycles.

13. The computer readable medium of claim 11 wherein the executable instructions dictate that the specified event occurs after a predetermined number of instances of a specified instruction.

14. The computer readable medium of claim 11 wherein the executable instructions dictate that the unexpected act is selected from an incorrect branch, a jump to a reset address, the invocation of a machine check exception, an invoked constant value, an invoked random value, and a skipped instruction.

15. A computer readable medium comprising executable instructions to describe:
a plurality of proprietary intellectual property blocks;
a key source block; and
an intellectual property core with a key check mechanism configured to:
compare an external key from the key source block with an internal key in response to a specified event,
execute a pending instruction in response to a match between the external key and the internal key, and
perform an unexpected act in response to a mismatch between the external key and the internal key.

16. The computer readable medium of claim 15 wherein the executable instructions dictate that the key source block stores a static key value.

17. The computer readable medium of claim 15 wherein the executable instructions dictate that the intellectual property core includes a status register block that stores a static key value.

18. The computer readable medium of claim 17 wherein the executable instructions dictate that the key source block produces a first key from an external random number generator responsive to a specified seed.

19. The computer readable medium of claim 18 wherein the executable instructions dictate that intellectual property core produces a second key from an internal random number generator responsive to the specified seed.

20. The computer readable medium of claim 19 wherein the executable instructions characterizing the internal random number generator are scrambled.

21. The computer readable medium of claim 19 wherein the executable instructions dictate that the specified seed is stored in a status register block of the intellectual property core.

22. A method of producing a system on a chip, comprising:
delivering an intellectual property core with a key check mechanism; and
combining the intellectual property core with a key source block and a set of proprietary intellectual property blocks.

23. The method of claim 22 further comprising specifying a system on a chip based upon the combined intellectual property core, key source block and set of intellectual property blocks.

24. The method of claim 23 further comprising fabricating the system on a chip.

25. The method of claim 22 wherein delivering includes delivering an intellectual property core with a scrambled random number generator.
